(19) United States
(12) Patent Application Publication
(10) Pub. No.: US 2025/0112348 A1
(43) Pub. Date: Apr. 3, 2025

(54) HOUSING

(71) Applicant: DEUTZ Aktiengesellschaft, Cologne (DE)

(72) Inventor: Oliver Günther Hoffmann, Grafschaft (DE)

(21) Appl. No.: 18/771,013

(22) Filed: Jul. 12, 2024

(30) Foreign Application Priority Data
Jul. 22, 2023 (DE) 10 2023 002 997.1

(51) Int. Cl. H01M 50/636; H01M 10/613; H01M 10/6567; H01M 50/204; H01M 50/271

(52) U.S. Cl. CPC H01M 50/636; H01M 10/613; H01M 10/6567; H01M 50/204; H01M 50/271

(57) ABSTRACT

A housing for an energy storage device, including a first housing element, which extends along a longitudinal axis and has a first side wall on a first longitudinal side and a second side wall on a second longitudinal side, between which a support section extends, a channel extending through the support section, through which a fluid can flow, and a first cover element, which together with the first housing element delimits at least part of a housing chamber and which is in contact with the first housing element at a front face of the latter, the support section having a transfer portion which includes an opening of the channel, and the first cover element having an aperture into which the transfer portion extends.

The present invention relates to a housing, in particular for an energy storage device.

Housings for energy storage devices have the purpose of accommodating the energy storage device and protecting it from environmental influences. Furthermore, housings for energy storage devices can include interfaces for transferring electrical energy between individual batteries or to an electrical load.

A housing, in particular for an energy storage device, is known from the German patent application 102022000414.3, comprising: an intermediate unit with an intermediate element in the form of a prism with an H-shaped base face and a longitudinal axis, wherein the intermediate element has a first side wall on a first longitudinal side and a second side wall on a second longitudinal side, between which a plate-shaped support section extends. A cover element is arranged on one front face of the intermediate element so that a housing chamber is defined by the intermediate element and the cover element. Channels extend through the support section in the direction of the longitudinal axis, which lead into an aperture in the cover element. The transition between the channels and the aperture is sealed by a circumferential weld seam that runs on the side of the housing chamber.

The invention has the underlying object of providing a housing that increases the protection of the housing chamber against leaks from the channels.

To achieve this objective, a housing is proposed, comprising a first housing element which extends along a longitudinal axis and has a first side wall on a first longitudinal side and a second side wall on a second longitudinal side, between which a support section extends, wherein a channel for feeding a fluid therethrough extends through the support section, and a first cover element, which, together with the first housing element, delimits at least part of a housing chamber and which is in contact with the first housing element at a front face thereof, wherein the support section has a transfer portion which comprises an opening of the channel, and the first cover element has an aperture into which the transfer portion extends.

In the housing according to the invention, the opening of the channel is therefore outside the housing chamber. If a leakage occurs in the area of the opening of the channel when liquid is transferred to the channel, the leakage can be detected from the outside, thus preventing fatal failure of the interior of the housing.

In particular, the housing can be designed as a housing for an energy storage device.

In one possible embodiment of the housing, the transfer portion can extend through the aperture.

In a further possible embodiment, a first connection element, which is fluidically connected to the channel, can be attached to the first cover element or the support section. A sealing element can be arranged between the first connection element and the transfer portion. The first connection element can have a recess in which the sealing element is arranged.

The sealing element can be in contact with the transfer portion on one side and in contact with the first connection element on an opposite side. The sealing element can be in contact with a front face of the transfer portion on one side and in contact with a front face of the first connection element on an opposite side. The sealing element can be in contact with an outer circumferential surface of the transfer portion on one side and in contact with an inner circumferential surface of the first connection element on an opposite side.

Alternatively or in combination, it is in particular also conceivable that the sealing element is in contact on one side with a front face of the first cover element and/or that an outer circumferential surface of the sealing element is in contact with an inner circumferential surface of the first cover element.

In one possible embodiment, the first connection element can have a ring section that surrounds the transfer portion.

In a further possible embodiment, the first cover element can have a recess which adjoins the aperture on a side facing away from the first housing element in a direction parallel to the longitudinal axis. The transfer portion can extend through the aperture into the recess or through the recess. The first connection element can be arranged at least partially in the recess.

In one possible embodiment of the housing, a second housing element may have a support section through which a channel extends. Furthermore, the housing can have a second cover element which is in contact with the second housing element at a front face. The first housing chamber can be at least partially bounded by the second housing element and the second cover element. In addition, the housing can comprise a second connection element that is fluidically connected to the channel of the second housing element. The second connection element can be attached to the second cover element or the support section.

The first connection element and the second connection element can be fluidically connected via a connection arrangement. The first connection element can have an interface in which a coupling element is arranged. The coupling element can be coupled to a tube element via which the first connection element and the second connection element are fluidically connected to each other.

An embodiment of the housing according to the invention is explained below with reference to the figures. Here

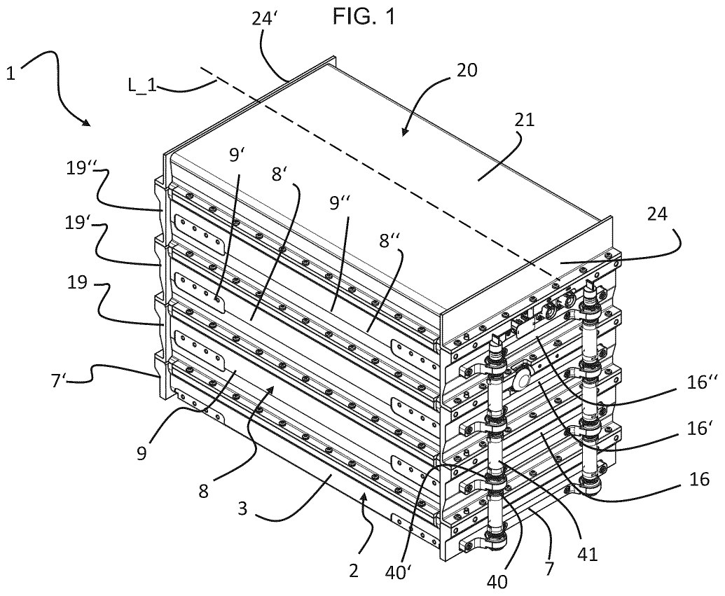

FIG. 1 is a perspective view of a housing for an energy storage device according to the invention;

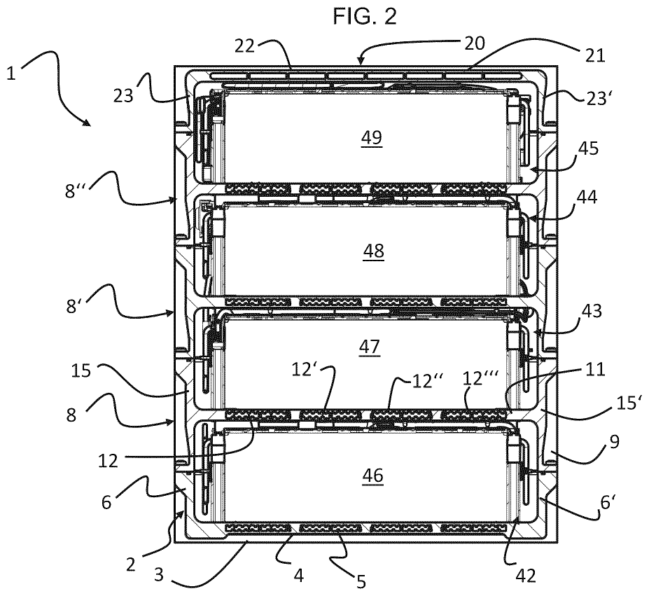

FIG. 2 is a cross-section of the housing according to FIG. 1;

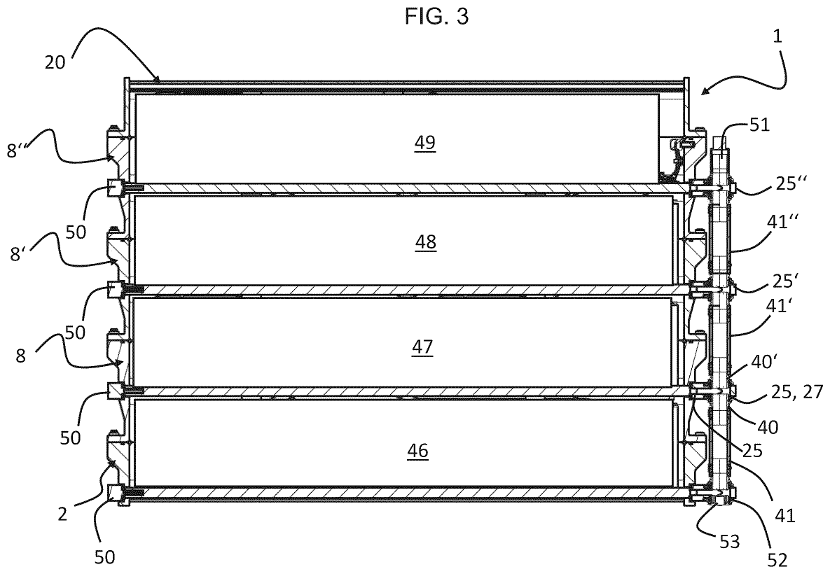

FIG. 3 is a longitudinal section of the housing from FIG. 1 through the coupling elements between the connection elements;

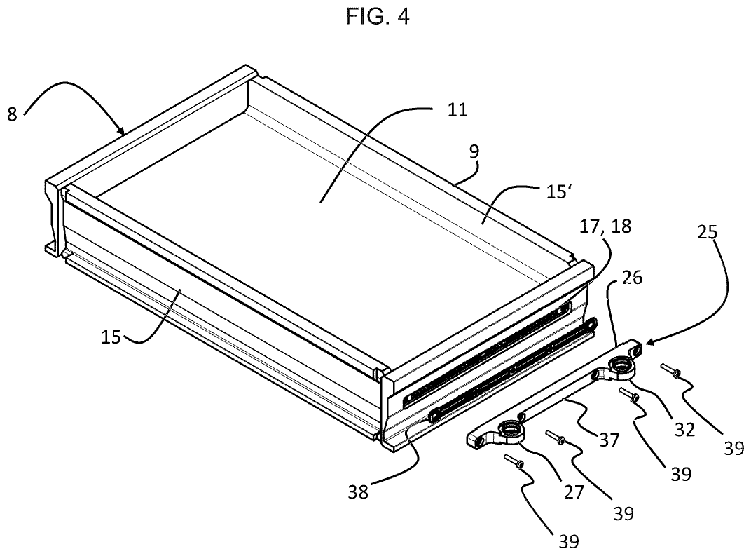

FIG. 4 is an exploded view of the first intermediate unit of the housing from FIG. 1;

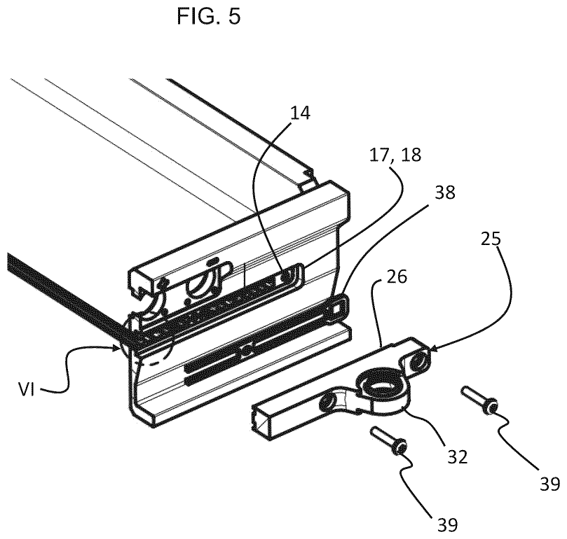

FIG. 5 is an enlarged perspective view of a longitudinal section of the first intermediate unit of the housing from FIG. 1;

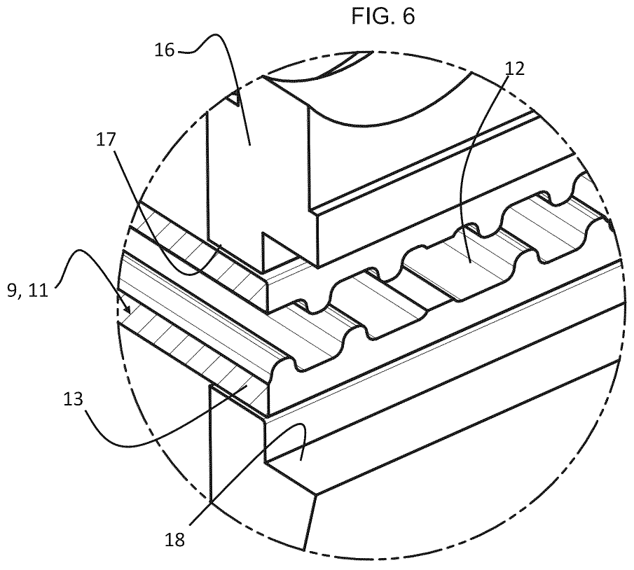

FIG. 6 is an enlarged view of detail VI from FIG. 5;

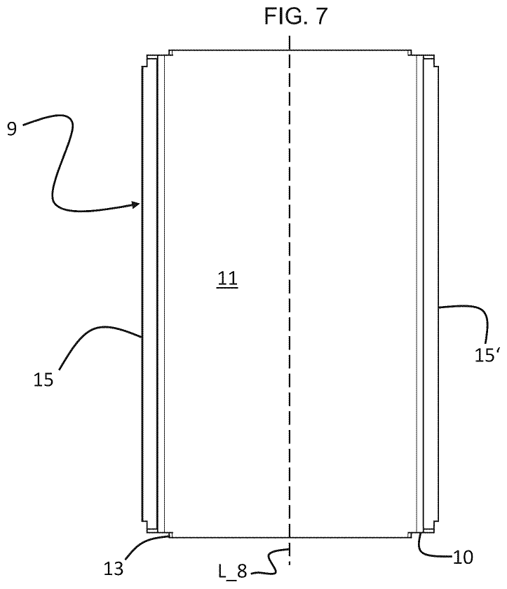

FIG. 7 is a top view of the intermediate element of the first intermediate unit of the housing from FIG. 1;

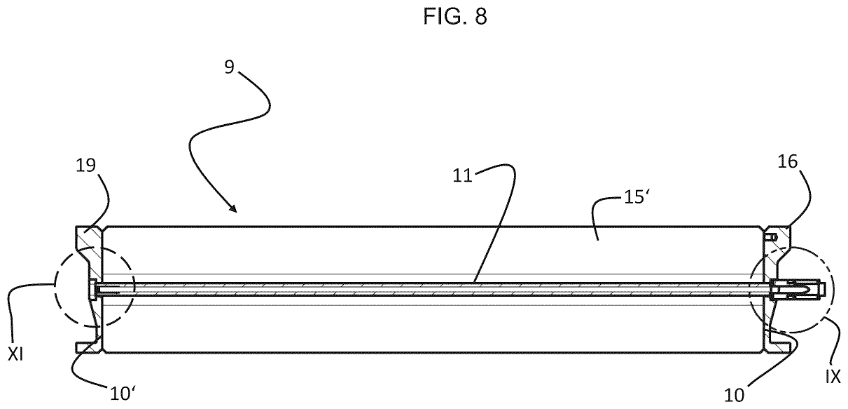

FIG. 8 a longitudinal section through the first intermediate unit of the housing from FIG. 1;

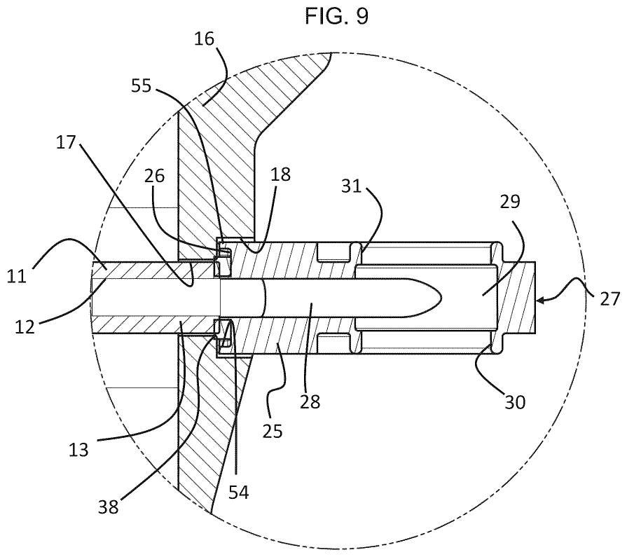

FIG. 9 is an enlarged view of detail IX from FIG. 8;

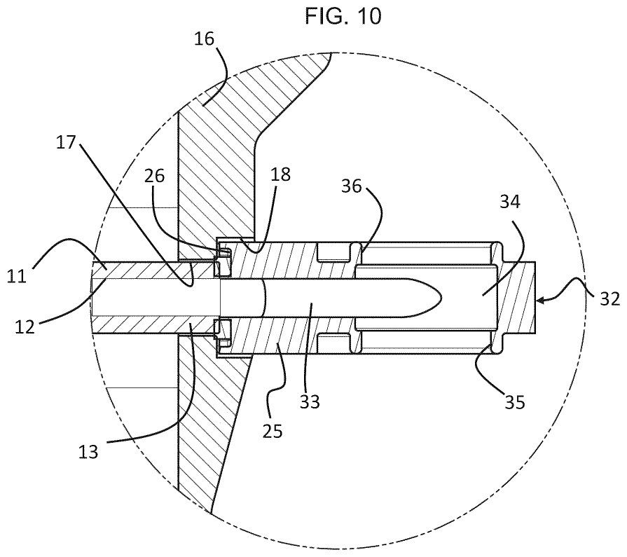

FIG. 10 is a view analogous to FIG. 9, with the outlet manifold section shown in place of the inlet manifold section of the connection element; and

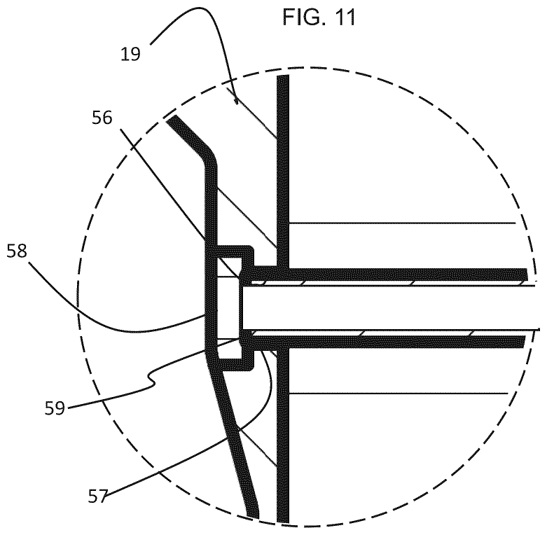

FIG. 11 is an enlarged view of detail XI from FIG. 8.

FIGS. 1 to 11, described together below, show a housing 1 for an energy storage device according to the invention. The housing 1 has a longitudinal axis L_1. The housing 1 comprises a base unit 2 and an end unit 20, between which three intermediate units 8, 8′ and 8″ are arranged.

The base unit 2 comprises a U-shaped base element 3, which is designed as a machined extruded profile and extends in a direction parallel to the longitudinal axis L_1. The base element 3 has a first side wall 6 and a second side wall 6′, each of which is arranged parallel to the longitudinal axis L_1. A plate-shaped base section 4 extends between the first side wall 6 and the second side wall 6′. Four cooling channels 5 extend through the base section 4 and are arranged parallel to the longitudinal axis L_1. The cooling channels 5 are formed into the base element 3 during the primary forming of the extruded profile.

Cover elements 7, 7′ of the base unit 2 are arranged on the front faces of the base element 3, which cover elements together with the base element 3 delimit a first housing chamber 42. A first battery arrangement 46 is arranged in the first housing chamber 42.

The base unit 2 is connected to a first intermediate unit 8 in such a way that together they enclose the first housing chamber 42.

The first intermediate unit 8 comprises an H-shaped intermediate element 9, which is designed as a machined extruded profile and extends along a longitudinal axis L_8. The longitudinal axis L_8 of the intermediate unit 8 is arranged parallel to the longitudinal axis L_1 of the housing. The intermediate unit 8 has a first side wall 15 and a second side wall 15′, which are arranged parallel to the longitudinal axis L_8 and the longitudinal axis L_1 of the housing 2 respectively. A plate-shaped support section 11 extends between the first side wall 15 and the second side wall 15′. The support section 11 is connected to the side walls 15, 15′ approximately in the middle of the latter. One or more cooling channels extend through the support section 11. In the present case, four cooling channels 12, 12′, 12″, 12′″ extend from one axial end to the other axial end through the support section 11, whereby the cooling channels 12, 12′, 12″, 12′″ are each arranged parallel to the longitudinal axis L_8 and the longitudinal axis L_1 respectively. The cooling channels 5 are formed into the intermediate element 9 during the primary forming of the extruded profile.

The support section 11 comprises an inlet cooling channel 12 and an outlet cooling channel 12″, which are fluidically connected to each other. In the present case, the inlet cooling channel 12 and the outlet cooling channel 12″′ are fluidically connected to each other via a first central cooling channel 12′ and a second central cooling channel 12″. Coolant is supplied to the inlet cooling channel 12 from a fluid source, for example a pump, and the coolant is discharged from the outlet cooling channel 12″′ into a fluid sink, for example a tank.

The intermediate element 9 has front faces 10; 10′ at opposite axial ends. A first cover element 16 is arranged on one front face 10 and a second cover element 19 is arranged on the opposite front face 10′, which cover elements together with the intermediate element 9 delimit the first housing chamber 42. The front faces 10, 10′ can also be referred to as axial contact surfaces, since the intermediate element 9 is in contact with the respective cover element 16, 19 with the front faces 10, 10′. In addition, a second housing chamber 43 is defined by the intermediate element 9 and the cover elements 16, 19.

The first intermediate unit 8 is connected to a second intermediate unit 8′ in such a way that together they enclose the second housing chamber 43. A second battery arrangement 47 is arranged in the second housing chamber 43.

The second intermediate unit 8′ is connected to a third intermediate unit 8″ in such a way that together they enclose the third housing chamber 44. A third battery arrangement 48 is arranged in the third housing chamber 44.

The third intermediate unit 8″ is connected to the end unit 20 in such a way that together they enclose a fourth housing chamber 45. A fourth battery arrangement 49 is arranged in the fourth housing chamber 45.

The end unit 20 comprises a U-shaped end element 21, which is designed as a machined extruded profile and extends in a direction parallel to the longitudinal axis L_1. The end element 21 has a first side wall 23 and a second side wall 23′, which are each arranged parallel to the longitudinal axis L_1. A plate-shaped cover section 22 extends between the first side wall 23 and the second side wall 23′. Cover elements 24, 24′ of the end unit 20 are arranged on the front faces of the end element 21, which together with the end element 21 delimit the fourth housing chamber 45.

The first intermediate unit 8, the second intermediate unit 8′ and the third intermediate unit 8″ are designed identically. The three intermediate units 8, 8′, 8″ are therefore described here together with reference to the first intermediate unit 8. The features described in the context of the first intermediate unit 8 are also realized identically in the second intermediate unit 8′ and the third intermediate unit 8″.

The support section 11 of the intermediate element 9 has a transition shoulder 13, which can also be referred to as a transfer portion or passage shoulder. The transition shoulder 13 adjoins the front face 10 of the intermediate element 9 in a direction parallel to the longitudinal axis L_8 or the longitudinal axis L_1. In other words, the transition shoulder 13 protrudes from the front face 10. The transition shoulder 13 comprises an opening in each of the cooling channels 12, 12′, 12″, 12″′. The openings can be designed either as inlet or outlet openings.

The first cover element 16 has an aperture 17. The aperture 17 is slot-shaped. The aperture 17 has a cross-section that is complementary to a cross-section of the transition shoulder 13. The first cover element 16 further has a recess 18, which adjoins the aperture 17 in a direction parallel to the longitudinal axis L_8.

The transition shoulder 13 extends into the aperture. In the present case, the transition shoulder 13 extends through the aperture 17 into the recess 18. One section of the transition shoulder 13 is thus arranged in the aperture 17 and another section of the transition shoulder 13 is arranged in the recess 18. In the present case, the respective opening of the cooling channels 12, 12′, 12″, 12″′ is arranged in the recess 18. It is also conceivable that the transition shoulder 13 extends through the recess 18, so that the respective opening of the cooling channels 12 is arranged outside the recess 18.

A connection element 25 is arranged in the recess 18. The connection element 25 is connected to the intermediate element 9 by means of fastening elements 39, which are designed as screws in the present case. The fastening elements 39 are each screwed into a threaded hole 14, which is formed in the transition shoulder 13. It is also conceivable that the connection element 25 is attached to the cover element 16 by means of the fastening elements.

The connection element 25 has an inlet manifold section 27, which is arranged in a direction parallel to the longitudinal axis L_8 in overlap with the inlet cooling channel 12. The inlet manifold section 27 is fluidically connected to a coolant source, which is designed as a pump. The inlet manifold section 27 has a connection recess 28, which is fluidically connected to the inlet cooling channel 12. The connection recess 28 extends in a direction parallel to the longitudinal axis L_8 or to the longitudinal axis L_1.

The connection recess 28 merges into a collection chamber 29. In the present case, the collection chamber 29 is cylindrical in shape and has a cylindrical axis which is arranged transversely and in particular orthogonally to the longitudinal axis L_8 or to the longitudinal axis L_1.

At a first end, the collection chamber 29 has a first interface 30, in which a first coupling element 40 is arranged in a sealed manner. The first coupling element 40 is tightly connected to a tube element 41. The tube element 41 has a tube axis which is arranged transversely and in particular orthogonally to the longitudinal axis L_8 or to the longitudinal axis L_1. The cylinder axis and the tube axis are arranged parallel to each other and, in particular, are identical.

At a second end opposite the first end, the collection chamber 29 has a second interface 31, in which a second coupling element 40′ is arranged in a sealed manner. The second coupling element 40′ is tightly connected to another tube element 41′. The tube element 41′ has a tube axis which is arranged transversely and in particular orthogonally to the longitudinal axis L_8 or to the longitudinal axis L_1. The cylinder axis and the tube axis are arranged parallel to each other and, in particular, are identical.

The tube element 41′ is fluidically connected to an inlet manifold section 27′ of a connection element 25′ of the second intermediate unit 8′. For this purpose, the tube element 41′ is tightly connected to the first coupling element 40 of the second intermediate unit 8′. In other words, the inlet manifold section 27 of the connection element 25 of the first intermediate unit 8 is fluidically connected to the inlet manifold section 27′ of the connection element 25′ of the second intermediate unit 8′ via the tube element 41′. Similarly, the inlet manifold section 27′ of the connection element 25′ of the second intermediate unit 8′ is fluidically connected to the inlet manifold section 27″ of the connection element 25″ of the third intermediate unit 8″ via a further tube element 41″. A tube element together with two connection elements can also be referred to as a fluidic connection arrangement.

The third intermediate unit 8″, which is connected to the end unit 20, has an end plug 51 instead of the second coupling element. The end plug seals the corresponding collection chamber at the second interface.

The base unit 2 has a connection element 52, which is fluidically connected to the cooling channels 5 of the base element 3 in the same way as connection element 25. The connection element 52 has an end plug 53 at the interface of the corresponding collection chamber, which faces away from the first intermediate unit 8.

The connection element 25 has an outlet manifold section 32, which is arranged in a direction parallel to the longitudinal axis L_8 in overlap with the outlet cooling channel 12″′. The outlet manifold section 32 is designed in the same way as the inlet manifold section 27.

The outlet manifold section 32 has a connection recess 33, which is fluidically connected to the outlet cooling channel 12″′. The connection recess 33 extends in a direction parallel to the longitudinal axis L_8 or to the longitudinal axis L_1. The connection recess 33 opens into a collection chamber 34. In the present case, the collection chamber 34 is cylindrical in shape and has a cylindrical axis which is arranged transversely and in particular orthogonally to the longitudinal axis L_8 or to the longitudinal axis L_1.

At a first end, the collection chamber 34 has a first interface 35, in which a first coupling element is arranged in a sealed manner. The first coupling element is tightly connected to a tube element. At a second end opposite the first end, the collection chamber 34 has a second interface 36 in which a second coupling element is arranged in a sealed manner. The second coupling element is tightly connected to another tube element.

The outlet manifold section 32 of the connection element 25 of the first intermediate unit 8 is fluidically connected to the outlet manifold section 32′ of the connection element 25′ of the second intermediate unit 8′ via a tube element. Similarly, the outlet manifold section 32′ of the connection element 25′ of the second intermediate unit 8′ is fluidically connected to the outlet manifold section 32″ of the connection element 25″ of the third intermediate unit 8″ via a further tube element. The design of the fluidic connection between two outlet manifold sections is analogous to the connection between two inlet manifold sections, so that reference is made at this point to the relevant explanations above for brevity.

The connection element 25 has an intermediate section 37, which connects the inlet manifold section 27 to the outlet manifold section 32. The intermediate section 37 can have a recess that fluidically connects the first central cooling channel 12′ and the second central cooling channel 12″. Alternatively, a fluidic connection between the first central cooling channel 12′ and the second central cooling channel 12″ can be realized by recesses in the support section 11.

A sealing element 38 is arranged between the transition shoulder 13 and the connection element 25. The connection element 25 has a recess 54 in which the sealing element 38 is arranged. The recess 54 extends into the connection element 25 in a direction parallel to the longitudinal axis L_1 or L_8. The recess 54 is bounded radially outwards by an annular shoulder 55. The shoulder 55 surrounds the sealing element 38 and the transition shoulder 13 at least partially.

The sealing element 38 is in contact on one side with a front face of the transition shoulder 13 and on an opposite side with a base face 26 of the recess 54. The base face 26 is part of the front face of the connection element 25.

As a result of the transition shoulder 13 passing through the aperture 17, leakage in the area of the sealing element 38 leads to coolant escaping outside the housing 1 and not into the housing 1. In this way, fatal damage to the battery arrangement can be avoided.

As can be seen in particular from FIG. 11, the second cover element 19 also has an aperture 56 through which a further transition shoulder 57 of the intermediate element 9 extends. The transition shoulder 57 has a cross-section that is complementary to the cross-section of the aperture 56. Openings of the cooling channels 12 are formed in the transition shoulder 57.

A sealing strip 58 is connected to the support section 11 via connecting means not shown. A further sealing element 59 is arranged between the sealing strip 58 and the front face of the transition shoulder 57. The sealing strip 58 can have a first recess which fluidically connects the inlet cooling channel 12 to the first central cooling channel 12′, and/or a second recess which fluidically connects the second central cooling channel 12″ to the outlet cooling channel 12″′. Alternatively, a fluidic connection between the inlet cooling channel 12 and the first central cooling channel 12′ and/or a fluidic connection between the second central cooling channel 12″ and the outlet cooling channel 12″′ can be formed in the support section 11.

### LIST OF REFERENCE SIGNS

1 Housing
2 Base unit
3 Base element
4 Base section
5 Cooling channels
6 Side wall
7 Cover element
8 Intermediate unit
9 Intermediate element
10 Front face
11 Support section
12 Cooling channels
13 Transition shoulder
14 Threaded bore
15 Side wall
16 Cover element
17 Aperture
18 Recess
19 Cover element
20 End unit
21 End element
22 Cover section
23 Side wall
24 Cover element
25 Connection element
26 Base face
27 Inlet manifold section
28 Connection recess
29 Collection chamber
30 Interface
31 Interface
32 Outlet manifold section
33 Connection recess
34 Collection chamber
35 Interface
36 Interface
37 Intermediate portion
38 Sealing element
39 Coupling element
40 Coupling element
41 Tube element
42 Housing chamber
43 Housing chamber
44 Housing chamber
45 Housing chamber
46 Battery arrangement
47 Battery arrangement
48 Battery arrangement
49 Battery arrangement
51 End plug
52 Connection element
53 End plug
54 Recess
55 Ring-shaped section
56 Aperture
57 Transition shoulder
58 Sealing strip
59 Sealing element
L Axis

1. A housing, in particular for an energy storage device, comprising:
a first housing element, which extends along a longitudinal axis and has a first side wall on a first longitudinal side and a second side wall on a second longitudinal side, between which a support section extends,
wherein a channel for feeding a fluid therethrough extends through the support section, and
a first cover element which, together with the first housing element, delimits at least part of a housing chamber and which is in contact with the first housing element at a front face thereof,
wherein the support section has a transfer portion comprising an opening of the channel, and
wherein the first cover element has an aperture into which the transfer portion extends.

2. The housing according to claim 1,
wherein a first connection element, which is fluidically connected to the channel, is attached to the first cover element or the support section.

3. The housing according to claim 2,
wherein a sealing element is arranged between the first connection element and the transfer portion, and
wherein the sealing element is in contact with the transfer portion on one side and in contact with the first connection element on an opposite side.

4. The housing according to claim 3,
wherein the first connection element has a recess in which the sealing element is arranged.

5. the housing according to claim 3,
wherein the sealing element is in contact with a front face of the transfer portion on one side and in contact with a front face of the first connection element on an opposite side.

6. The housing according to claim 3,
wherein the sealing element is in contact with an outer circumferential surface of the transfer portion on one side and in contact with an inner circumferential surface of the first connection element on an opposite side.

7. The housing according to claim 2,
wherein the first connection element has a ring section which surrounds the transfer portion.

8. The housing according to claim 1,
wherein the first cover element has a recess which adjoins the aperture on a side facing away from the first housing element in a direction parallel to the longitudinal axis, and
wherein the transfer portion extends through the aperture into the recess or through the recess.

9. The housing according to claim 8,
wherein the first connection element is arranged at least partially in the recess.

10. The housing according to claim 1, further comprising:
a second housing element which has a support section through which a channel extends,
a second cover element, which is in contact with the second housing element at one front face thereof,
wherein the first housing chamber is at least partially bounded by the second housing element and the second cover element, and
a second connection element, which is fluidically connected to the channel of the second housing element and is attached to the second cover element or the support section,
wherein the first connection element and the second connection element are fluidically connected via a connection arrangement.

11. The housing according to claim 10,
wherein the first connection element has an interface in which a coupling element is arranged, and
wherein the coupling element is coupled to a tube element, via which the first connection element and the second connection element are fluidically connected to one another.
